(19) United States
(12) Patent Application Publication
(10) Pub. No.: US 2001/0039137 A1
(43) Pub. Date: Nov. 8, 2001

(54) X-ray fluorescence analysis apparatus

(76) Inventors: Koichi Tamura, Chiba-shi (JP); Mitsuo Naito, Chiba-shi (JP)

Correspondence Address: ADAMS & WILKS, 31st Floor, 50 Broadway, New York, NY, 10004, US

(21) Appl. No.: 09/833,145

(22) Filed: Apr. 11, 2001

(30) Foreign Application Priority Data
Apr. 12, 2000 (JP) 2000-110853

(51) Int. Cl. H01R 4/38

(52) U.S. Cl. 439/320

(57) ABSTRACT

The present invention sets out to provide X-ray fluorescence analysis apparatus having an easily detached protective sheath having a structure where conduction is provided between a core and a shield when the high-voltage connector is open. A pipe-shaped sheath having threading corresponding to a fixing screw connecting to a shield of the high-voltage connector is provided, and a conductor touching with the core is provided at the other end of the sheath. When the sheath is then fitted to the high-voltage connector, the core of the high-voltage connector and the shield conduct.

### BACKGROUND OF THE INVENTION

The present invention relates to an X-ray fluorescence analysis apparatus for carrying out non-destructive elementary analysis, and more particularly relates to an X-ray fluorescence analysis apparatus divided up into a measuring unit housing and X-ray tube and a power supply unit housing a high-voltage power supply.

X-ray fluorescence analysis apparatus where a measuring unit housing an X-ray tube and a power supply unit housing a high-voltage power supply are separate are well known in the related art. In particular, with portable X-ray fluorescence analysis apparatus, the apparatus are separated to make the size and weight of each individual unit smaller and therefore easier to carry. Further, on the other hand, with X-ray fluorescence analysis apparatus with an opening on the outer side of the apparatus from which X-rays are radiated, it is preferable in particular for a measuring unit housing to be small and lightweight in order to move a measuring unit housing containing a tube and position this housing at a region of a material it is desired to measure.

In order to make the measuring unit housing small and lightweight, tests have been carried out where a high-voltage power supply for applying a high-voltage to an X-ray tube is separated from the measuring unit, with the measuring unit housing and the high-voltage power supply being connected by a high-voltage cable. However, situations where a separable configuration where the high-voltage cable can be separated using one or more high-voltage connectors are common.

However, with apparatus of this configuration, the high-voltage connector is taken outside during transportation and moving. However, load is accumulated between the high-voltage cables even if no high-voltage is applied to the high-voltage power supply, due to contact between conductors within the high-voltage cable at this time, i.e. the high-voltage cable may apply a high-voltage of, for example, 50,000V to the core at this time, namely, the material and thickness etc. of the insulator covering the core must be devised in such a manner that insulation is not damaged by the application of a high-voltage, i.e. the insulating resistance is extremely large. As a result, when the high-voltage cable is, for example, rubbed, in an open state, according to capacitor theory charge is accumulated but cannot easily be discharged because of the height of the insulation resistance.

If the core of the cable is then touched with the cable in this charged state, an electric shock due to static electricity will be experienced.

In order to resolve the aforementioned problems, the present invention sets out to provide X-ray fluorescence analysis apparatus having an easily detached protective sheath having a structure where conduction is provided between a core and a shield when the high-voltage connector is open.

### SUMMARY OF THE INVENTION

The present invention adopts the following means in order to resolve the aforementioned problems.

X-ray fluorescence analysis apparatus comprising: a first housing for housing an X-ray tube for irradiating a sample to be measured with primary X-rays; a second housing for housing a high-voltage power supply for supplying a high-voltage to the X-ray tube; and a high-voltage cable connecting the X-ray tube and the high-voltage power supply, wherein at least one end of the high-voltage cable is a high-voltage connector, the high-voltage connector is constituted by a core, an insulator covering the core, and a fixing screw; there is provided a detachable pipe-shaped sheath, covering a core of the high-voltage connector and covering the core, having a screw corresponding to the fixing screw for enabling fixing, and the sheath has a conductor formed at an inner surface thereof so that the core of the high-voltage connected makes contact when fixed to the fixing screw.

Here, the X-ray tube and high-voltage power supply are connected by a high-voltage cable but with the aforementioned portable or open-type apparatus, the housing containing the X-ray tube is made as small and lightweight as possible in order to be located close to the subject to be measured and the heavy high-voltage power supply is provided as a separate housing, with it being wished to make the intervening high-voltage cable long. However, having a long high-voltage cable in a continually connected state is detrimental to handling and also troublesome with respect to transportation and structures where the high-voltage cable is detachable at one or more locations using a high-voltage connector are common.

A structure for an example of a high-voltage connector used in this kind of application is shown in FIG. 2.

A core 21 is a wire for applying a high-voltage of, for example, 50,000V, and cladding is provided by an insulator 22 so that this high-voltage is not discharged to outside of the cable. Shielding wiring 23 is provided on the outside of the insulator 22 and is electrically connected to a metal fixing screw 24. Protective cladding is provided on the outside of the shielding wiring 23.

In order to connect the high-voltage connector, a plug 25 is inserted into a receptacle for an opposing side of, for example, a high-voltage power supply or an X-ray tube, etc., and the fixing screw 24 screws into a corresponding thread on the receptacle so as to become fixed.

In the present invention, a portion of the plug 25 is covered by a pipe-shaped sheath. Threading corresponding to the fixing screw 24 is cut in one end of the sheath so that fixing of the sheath to the high-voltage connector is possible without using any other means.

A conductor is provided at the other end of the sheath in such a manner that the end of the core makes contact with the conductor when the sheath is fixed using the fixing screw. The conductor may be, for example, a metallic cone-shaped cap.

The conductor at the end of the sheath is also configured so that there is conductance with the fixing screw. For example, the whole of the sheath may be metal, with the conductor being fixed using fixing means such as welding or soldering.

If the sheath is made of a stiff pipe consisting of metal, etc., then the sheath may also be used as a protective cover for preventing contamination of the core and insulator.

With the above mechanism, when the sheath covers and is screwed into the high-voltage connector, there is conduction between the shield and core of the high-voltage cable, Therefore, even is a charge is generated due to friction etc., this flows away immediately so that there is no build-up of charge and no electric shock incurred when the core is touched.

### BRIEF DESCRIPTION OF THE DRAWINGS

FIG. 1 is a schematic view showing an apparatus constituting an embodiment-of the present invention.

FIG. 2 is a view illustrating a high-voltage connection unit of this apparatus.

FIG. 3A is a schematic view showing a further configuration for a conductor.

FIG. 3B is a schematic view showing a further configuration for a conductor.

FIG. 4 is a schematic view showing an apparatus constituting a further embodiment of the present invention.

### DETAILED DESCRIPTION OF THE PREFERRED EMBODIMENT

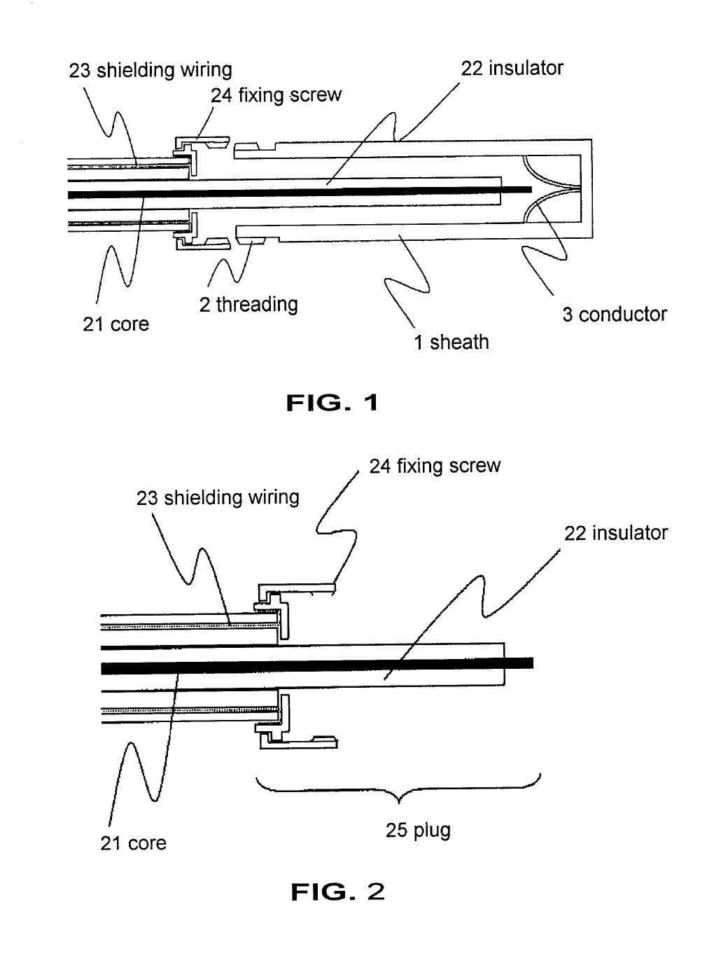

The following is a description, with reference to FIG. 1, of a preferred embodiment of the present invention.

An X-ray tube and a high-voltage power supply for supplying a high-voltage to the X-ray tube are connected via a high-voltage cable. Making a high-voltage cable detachable by providing one or more high-voltage connectors is common in order to make transportation and handling straightforward. This kind of high-voltage connector comprises, for example, a core 21 constituting a wire to which a high-voltage is applied, an insulator 22 covering the core 21 in such a manner that high-voltages are not discharged to outside of the cable, shielding wiring 23 on the outside of the insulator 22, and a metal fixing screw 24 electrically connected to the shielding wire 23.

In order to connect the high-voltage connector, as shown in FIG. 2, a plug 25 is inserted into a receptacle for an opposing side of, for example, a high-voltage power supply or an X-ray tube, etc., and the fixing screw 24 screws into a corresponding thread on the receptacle so as to become fixed.

The thickness and materials used for the insulator 22 employed here are selected in such a manner as to provide resistance to high-voltages so as to give a capacitor structure where the core 21 and the shield 23 can be viewed as electrodes. If the high-voltage cable is moved when the high-voltage connector is off, charge is accumulated due to static electricity caused by rubbing between the conductors within the cables. In order to avoid this, it is preferable for the core 21 and the shielding wiring 23 to be short-circuited.

In the present invention, a sheath 1 is provided in order to protect the plug 25 of the high-voltage connector so as to bring about the aforementioned short-circuiting function, i.e. a metal pipe-shaped sheath 1 is provided so as to cover the plug 25 of the high-voltage connector and threading 2 corresponding to the fixing screw 24 of the high-voltage connector is provided at one end of the sheath 1. This means that fixing to the high-voltage connector is straightforward. The end at the opposite side of the sheath 1 is formed of a conductor 3 made of a conductor such as metal etc. The conductor 3 consists, for example, as shown in the drawings, of two plate springs lined up with each other at the inner surface of the sheath and fixed by braising, soldering or some other fixing method so as to make electrical contact by pushing, etc. The conductor 3 is located in such a manner that the end of the core 21 comes into contact with the conductor 3 when the sheath 1 is fixed using the fixing screw 24.

The conductor 3 in FIG. 1 is urged outwards to a location close to the side of the high-voltage connector on the outside of the inner surface of the sheath 1 and is of a construction where its width narrows in accordance with the progression of the central part. When the conductor 3 is taken to be a flat plate and the end of the core 21 touches the conductor when the plug 25 is inserted into the sheath 1, the core 21 is pushed against the conductor when the fixing screw 24 is fastened, and the plug may become damaged due to more force than is necessary being applied to the plug. On the other hand, the plug 25 will definitely not stand up straight by itself as shown in the drawings, but will instead become curved. It is therefore necessary to provide some relief so that the core is not subjected to more force than is necessary when the end of the core 21 curved at the time of insertion of the plug makes contact with the conductor in a reliable manner while the fixing screw 24 is being fastened. This therefore gives the shape shown in FIG. 1.

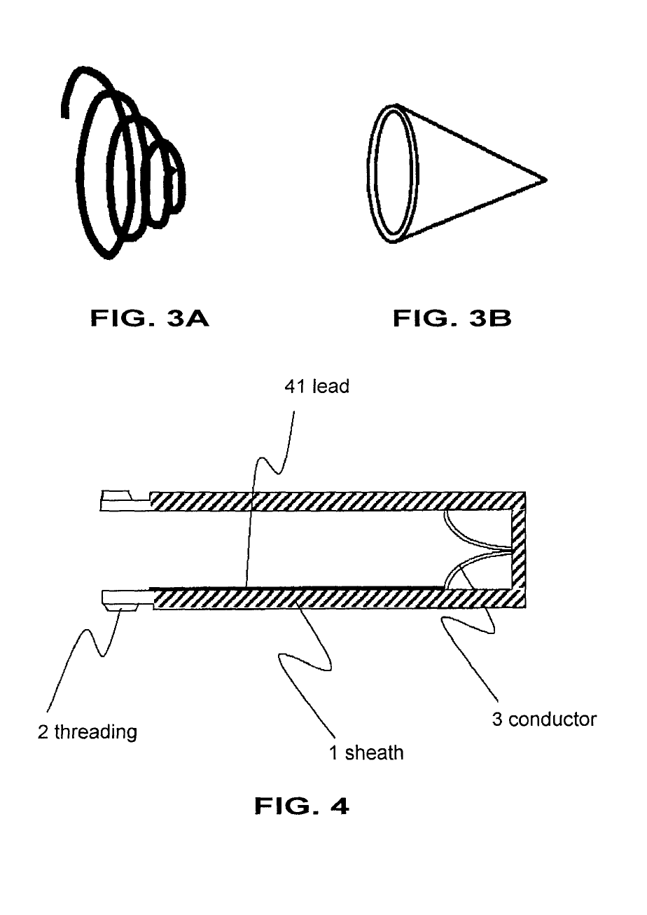

The shape of the conductor 3 is by no means limited to that shown in FIG. 1, and may be any shape that achieves the aforementioned object. For example, the conductor 3 may be a spring material wrapped around in a spiral as shown in FIG. 3A, or may be a cone-shaped metal cup with no bottom, as shown in FIG. 3B. Alternatively, although this is not shown in the drawings, the aforementioned object may be achieved by using an item such as a steel brush so that more stress than is required is not exerted during fastening of the fixing screw.

Further, it is by no means necessary for the sheath material to be metal and, as shown in FIG. 4, a portion of the thread 2 and the conductor 3 may consist of metal or a material consisting of conductive coating so that is the screw 2 and the conductor 3 are made to conduct by the lead 41, the material of the portion shown by the slanted lines becomes irrelevant. Metal plate or wiring can be used as the lead 41 so that the screw 2 and conductor 3 make electrical contact.

According to the present invention, due to the presence of a protective sheath having a structure where the core and the shield conduct when the high-voltage connector is open, if a protective sheath and high-voltage connector are fitted, there is conduction between a core of a high-voltage connector and a shield, so that charge does not accumulate at the high-voltage cable and an electric shock due to static electricity is not incurred even if the core is touched.

Further, by providing threading corresponding to the fixing screws of the high-voltage connector, other screws etc. in addition to the fixing means are not necessary and straightforward attachment/detachment is possible.

What is claimed is:

1. X-ray fluorescence analysis apparatus comprising:
a first housing for housing an X-ray tube for irradiating a sample to be measured with primary X-rays;
a second housing for housing a high-voltage power supply for supplying a high-voltage to the X-ray tube;
and a high-voltage cable connecting the X-ray tube and the high-voltage power supply,
wherein at least one end of the high-voltage cable is a high-voltage connector,
the high-voltage connector is constituted by a core, an insulator covering the core, and a fixing screw,
there is provided a detachable pipe-shaped sheath, covering a core of the high-voltage connector and covering the core,
having threading corresponding to the fixing screw for enabling fixing,
and the sheath has a conductor formed at an inner surface thereof so that the core of the high-voltage connected makes contact when fixing to the fixing screw.
